(19) United States
(12) Patent Application Publication
(10) Pub. No.: US 2020/0387957 A1
(43) Pub. Date: Dec. 10, 2020

(54) MERCHANDISE SHIPPING FEE CALCULATING SYSTEM IN ELECTRONIC COMMERCE

(71) Applicant: Kwon Suk KOH, Seoul (KR)

(72) Inventor: Kwon Suk KOH, Seoul (KR)

(21) Appl. No.: 17/001,119

(22) Filed: Aug. 24, 2020

Related U.S. Application Data
(63) Continuation-in-part of application No. 15/770,759, filed on Apr. 25, 2018, now abandoned.

(30) Foreign Application Priority Data
Nov. 5, 2015 (KR) 10-2015-0154866

(51) Int. Cl. G06Q 30/06; G06Q 10/08; G06F 3/0482

(52) U.S. Cl. CPC G06Q 30/0641; G06Q 30/0625; G06F 3/0483; G06Q 10/08345; G06F 3/0482; G06Q 10/087

(57) ABSTRACT

A method for managing online shopping at an online store offering products of a plurality of sellers is provided. The method includes receiving from a plurality of sellers lists of products and product information; receiving from a plurality of shipping companies delivery costs and address format; receiving from a buyer a product input including an indication regarding a desired product; conducting a search in the product database in accordance with the product input and retrieving a list of relevant products; retrieving from the delivery database delivery costs of each of the relevant products in accordance with the selected shipping company; calculating shipping price of each of the relevant products in accordance with the location address; and displaying to the buyer the list of relevant products including price of each product and shipping price of each product.

### FIELD OF INVENTION

The presently disclosed subject matter relates to a system and method for delivery fee calculation system of goods' in ecommerce.

### BACKGROUND

When buyer purchases the goods through ecommerce, the buyer connects the website of ecommerce and selects the goods among the products listed according to product type and price. If the buyer selects the goods, buyer enters the information for goods delivery such as personal information and receipt address etc (Also when the buyer joins as a member, the buyer can enter the receipt address). The buyer pays the product price plus delivery charges through real-time transfer or credit card.

After payment was done, the seller sends the goods to receipt address. In this case, the product is delivered by the delivery company.

Generally, when the buyer purchases the products more than a certain amount of goods in domestic, delivery charge is often free. If the delivery fee is included, a fixed amount on a flat rate is usually charged.

The international delivery cost is relatively higher than domestic. If the sender sends the goods to a certain city in certain state of certain country around the world from seller located, the expected delivery cost could not be predicted accurately.

Most ecommerce sites currently do not provide accurate delivery charge on their site In the case of delivering all over the world. Most sites do not offer reasonable delivery charge, but calculate estimated delivery cost that there is no loss due to delivery in advance, and then it only informs the purchaser unilaterally.

Because the delivery charge information provided by the site operator in advance is provided unilaterally, not the actual delivery charge information, from the buyer's point of view, it is often necessary to pay more than the actual delivery cost.

From the seller's point of view, if the delivery fee calculated in advance is lower than the actual delivery fee, seller have to pay more the delivery charge amount than buyer pay the actual delivery charge amount.

There is a problem that the seller can incur an unavoidable loss in the delivery charge.

Some sites do not set a specific delivery charge, but only estimate the approximate delivery fee. In this case, the buyer may have to pay unreasonably the actual delivery fee more than expected.

If people purchase a goods for $ 30 on an ecommerce site located in the United States, buyer may also have to pay a delivery fee of $ 20 without any further notice.

On some sites, when an administrator of site enters addresses for each country, the seller uses the addresses to create a delivery zone based on place of goods shipment and enters the delivery price in each delivery zone. Using the address provided by the administrator; buyer enters the address where buyer wants to receive the purchased product.

In order to sellers increase the competitiveness of commodity prices, seller should create a detailed product delivery zone from where the seller is located. This was problematic in that it was cumbersome and inconvenient.

### SUMMARY OF INVENTION

According with an aspect of the presently disclosed subject matter there is provided a method for managing online shopping at an online store offering products of a plurality of sellers. The method includes receiving from a plurality of sellers lists of products and product information associated with each product, the product information including location address the product, size of the product, price of the product and a selected shipping company; the lists of products and product information is stored in a product database; receiving from a plurality of shipping companies delivery costs and address format, the delivery costs includes parameters for calculating delivery cost in accordance with products size, and delivery address; the delivery costs and address format is stored in a delivery database; prompting a from to enter delivery address; receiving from a buyer a product input including an indication regarding a desired product; conducting a search in the product database in accordance with the product input and retrieving a list of relevant products; retrieving from the delivery database delivery costs of each of the relevant products in accordance with the selected shipping company; calculating shipping price of each of the relevant products in accordance with the location address, the delivery address, size of the relevant product, and the selected shipping company; and displaying to the buyer the list of relevant products including price of each product and shipping price of each product.

The method can further include receiving from the buyer an indicated of at least one selected product; sending a seller of the selected products order instructions; converting the delivery address to a delivery zone adapted in accordance with the address format of the selected shipping company associated with the selected product; and sending the delivery zone to the selected shipping company along with product information.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1 is a schematic diagram showing a ‘delivery fee calculation system of goods’ in ecommerce according to an embodiment of the present invention.

FIG. 2 is a schematic block diagram showing ‘management server’ of FIG. 1.

FIGS. 3a and 3b are diagrams showing before and after the delivery zone information is confirmed through the ‘delivery fee calculation system of goods’ of FIG. 1 in ecommerce site.

FIGS. 4a and 4b are diagrams showing how to create the address zone, through the ‘delivery fee calculation system of goods’ of FIG. 1 in ecommerce site.

FIG. 5 is a diagram showing the ‘confirm unit of receipt address information’ of FIG. 2, and showing the correlation between the Delivery Company's code and the postal code.

FIG. 6 is a diagram showing operation of ‘choice unit of delivery method’, and ‘create unit of currency’ of FIG. 2 in ecommerce site.

FIGS. 7a and 7b are diagrams showing operation of ‘payment carry out unit’ of FIG. 2 in ecommerce site.

FIG. 8 is a diagram showing creating of other currencies through the ‘create unit of currency’ of FIG. 2 in ecommerce site.

FIG. 9 is a flowchart showing a calculation process of delivery fee in the ‘delivery fee calculation system of goods’ of FIG. 1, when the ‘information of first delivery zone’ is selected in ecommerce site.

### DETAILED DESCRIPTION OF EMBODIMENTS

One embodiment of the present invention, provides a ‘delivery fee calculation system of goods’ in ecommerce which calculates the delivery fee in domestic or overseas commerce, through information of domestic or overseas address registered in ecommerce site and through accessed and authorized ‘seller terminal’ or ‘delivery company terminal’ to ecommerce site.

Also one embodiment of the present invention provides a ‘delivery fee calculation system of goods’ in ecommerce which the address information provided by the administrator of ecommerce site can be used together by the seller, buyer and delivery company.

The ‘delivery fee calculation system of goods’ in ecommerce is a system for calculating the delivery fee in domestic or overseas commerce, through information of domestic or overseas address registered in ecommerce site, and through accessed and authorized ‘seller terminal’ or ‘delivery company terminal’ to ecommerce site.

The ‘management server’ for operating and managing the electronic commerce site includes the following. A ‘create unit of address zone’ which creates the address zone of domestic and overseas consist of city, states zone and nation, through the ‘management terminal’ managing the ecommerce site; A ‘input unit of delivery zone’ which enters the information of delivery zone for product delivery by one or more ‘delivery company terminal’ or ‘seller terminal’ based on the created address zone. A ‘determination unit of delivery zone’ which confirms the information of desired delivery zone by ‘seller terminal’; A ‘select unit of delivery goods’ which confirms the information of goods and outbound shipping address of goods, enters the price information of goods by ‘seller terminal’; A ‘choice unit of delivery method’ which selects and inputs the delivery way, delivery method and delivery fee of delivery commodity by sellers terminal; A ‘create unit of currency’ which creates the currency about the product price by seller terminal; A ‘confirm unit of receipt address information’ which selects the information of receipt address where receipts a specific goods based on the delivery zone information by ‘buyer terminal’ that want to purchase the product from ecommerce site; And a ‘calculate unit of delivery fee’ which calculated delivery fees of a certain products automatically corresponding to the outbound shipping place information and receipt address information based on the delivery fee information;

The management server includes the following. A ‘code providing unit’ which provides product code or company code to the ‘seller terminal’ or the ‘delivery company terminal’; A ‘copy unit of delivery zone’ which can copy and share the information of delivery zone created by ‘seller terminal’ or ‘delivery company terminal’; A ‘storage unit’ which stores the information of addresses zone and delivery zones, goods information about the products, information of product outbound shipping place, information of product price, delivery methods, delivery ways, delivery fee, currency and information of receipt address. A ‘control unit’ which controls the operation of each component configuring the management server;

The ‘create unit of address zone’ may be compatible with the address related to the postal code of each country, when an address zone is created by the ‘management terminal’ managing a website. Also, can be entered the address with one or more languages by ‘management terminal’.

The ‘copy unit of delivery zone’ can share the delivery zone information by a request from another ‘seller terminal’ and permission of the ‘management terminal’ of the ecommerce site.

The ‘select unit of delivery goods’ provides the ‘information of first delivery zone’ to the ‘storage unit’, when the ‘information of first delivery zone’ inputted by the ‘seller terminal’ is selected and the ‘information of first delivery zone’ can be set possible to add, modify and delete by the ‘sellers terminal’.

The ‘select unit of delivery goods’ supplies the ‘information of second delivery zone’ to the ‘storage unit’ When the ‘information of second delivery zone’ inputted by the ‘delivery company terminal’ is selected, and the ‘seller terminal’ can select the ‘information of second delivery zone’ as inputs code information including at least one of a code number, a bar code or a QR code provided from the ‘delivery company terminal’.

The ‘seller terminal’ uses the delivery method, the delivery way, and the delivery fee set by the ‘delivery company terminal’ or can apply after enters the delivery methods, delivery ways and delivery fees directly.

The currency exchange program for exchanging money or currency unit between domestic and foreign currency is installed in advance in ‘create unit of currency’, information of Key Currency, and information of seller's and buyer's currency that seller and buyer want to receive or pay, and information of exchange rate provided by the delivery company or bank, and fee Information charged when exchanging money by exchange rate information by executing of the exchange program is provided in the ‘create unit of currency’.

The ‘management server’ may include ‘payment carry out unit’ which carry out the payment by ‘buyer terminal’ who want to purchase the product using the information of Key Currency, Seller Currency, Buyer Currency, the exchange rate and exchange fee.

The cities, state zones, and nations forming the address zone can be inherently coded into any one of numbers, symbols, characters, a barcode, and a QR code.

The ‘confirm unit of receipt address information’ can use the languages and the postal codes of each country when the address is inputted by the ‘buyer terminal’.

If the ‘information of first delivery zone’ inputted by ‘seller terminal’ is selected, the ‘calculate unit of delivery fee’ can calculate the delivery fee inputted for each nation, each state zone and each city judging nations, state zones and cities of ‘receipt address information’ corresponding to nations, state zones and cities of ‘outbound shipping address information’ are sequentially the same or not.

The ‘delivery fee calculation system of goods’ in ecommerce according to one embodiment of the present invention means the following, the seller can provide the optimum price which determines goods price and delivery cost with minimum effort to the buyer because the product delivery charge is calculated in ecommerce of domestic or overseas, through connected and authenticated ‘seller terminal’ or ‘buyer terminal’ in ecommerce site, and through the address information of domestic or oversea registered by the administrator of ecommerce site.

Also this invention is possible to improve the work efficiency of not only the manager of the ecommerce site but also the seller and the delivery company, because seller, buyer and Delivery Company use address information together provided by the administrator of the ecommerce site, and delivery fee according to the delivery zone provided by the seller and the delivery company.

The terms used in this specification are briefly described; also this invention will be described in detail.

The terms used in the present invention have selected the general terms that are widely used now considering the function of the present invention, but this can be changed depending on the Intentions of skilled person engaged in this field, or precedents and emergence of new techniques. There are also terms chosen arbitrarily by the applicant in certain cases and the meaning is described in detail in the relevant part of the invention. Therefore, the term used in the present invention should be defined based on the meaning of the term and the contents throughout the present invention, not on the name of a simple term.

When a certain part is “includes” a certain component throughout the specification, it means not to exclude other elements, but may include other elements unless opposite writes specifically. A term of “_unit” described in the specification means one or more function or a unit that processes an operation and it can be implemented as in hardware or software or a combination of hardware and software.

The present invention will be described in detail so that it can be easily carried out by a person having ordinary knowledge referring to the accompanying drawings for the embodiment of the present invention. The present invention may be embodied in many different forms, and the present invention is not limited to the embodiments described herein. Parts not related to the explanation are omitted to clarify the invention in the drawings. The similar part is marked with the similar sign of drawing throughout the specification.

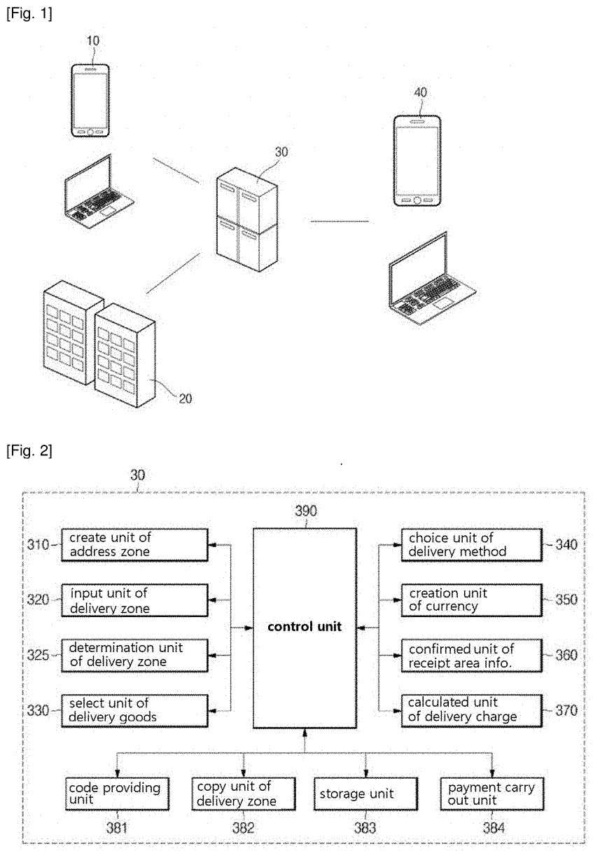

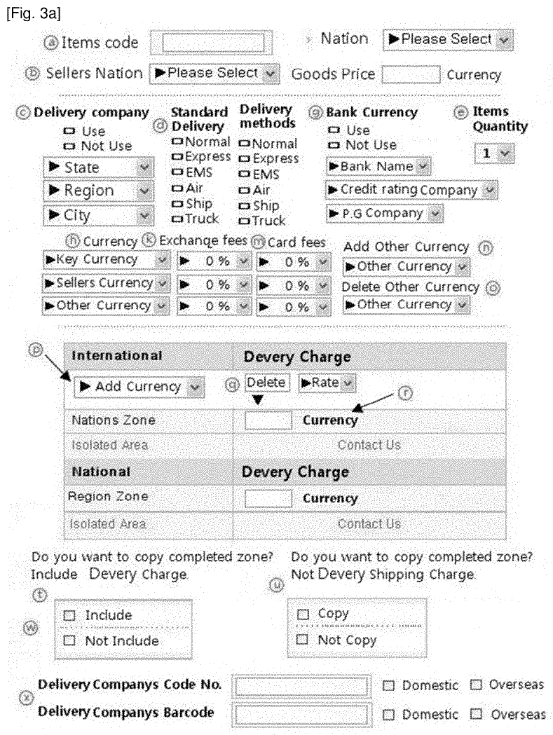

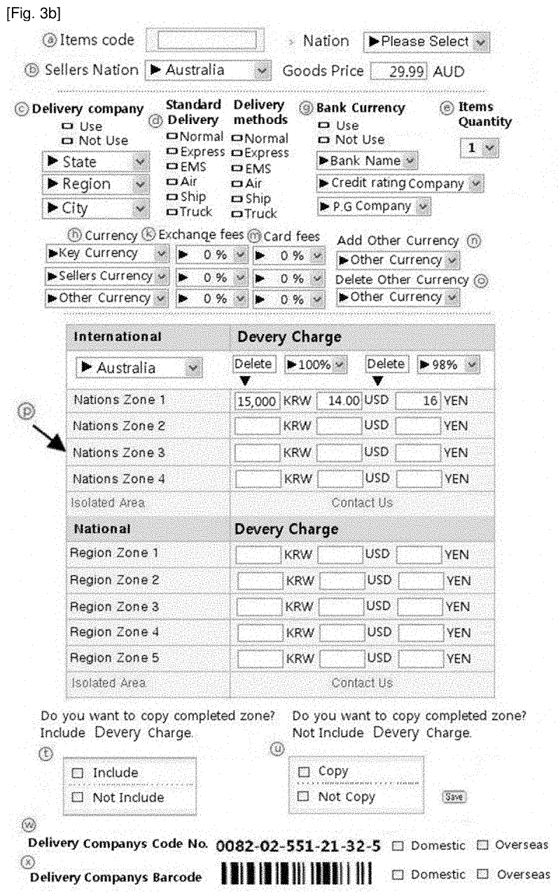

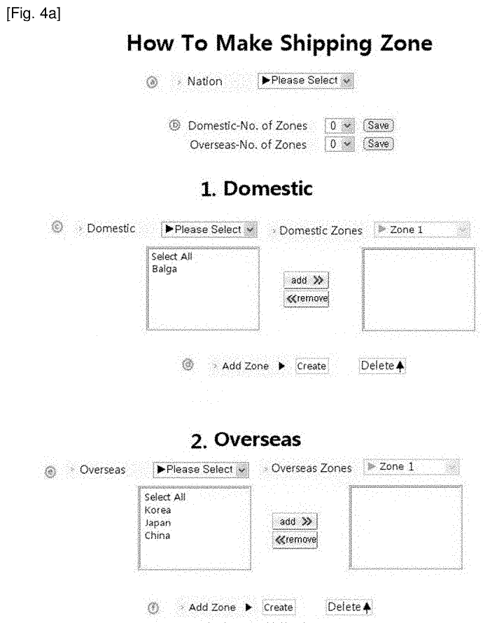

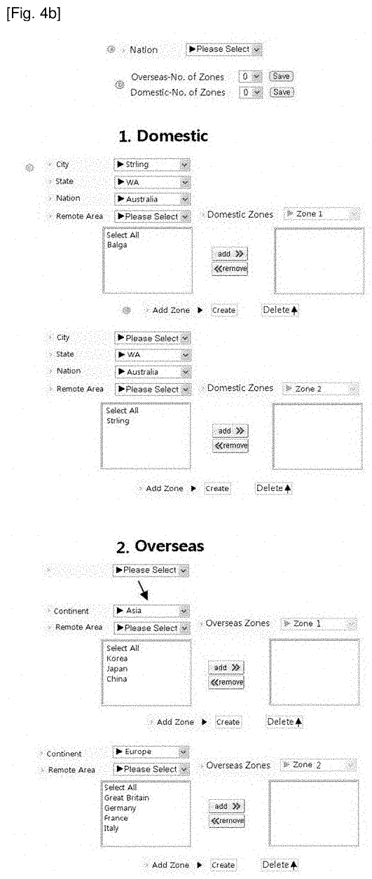

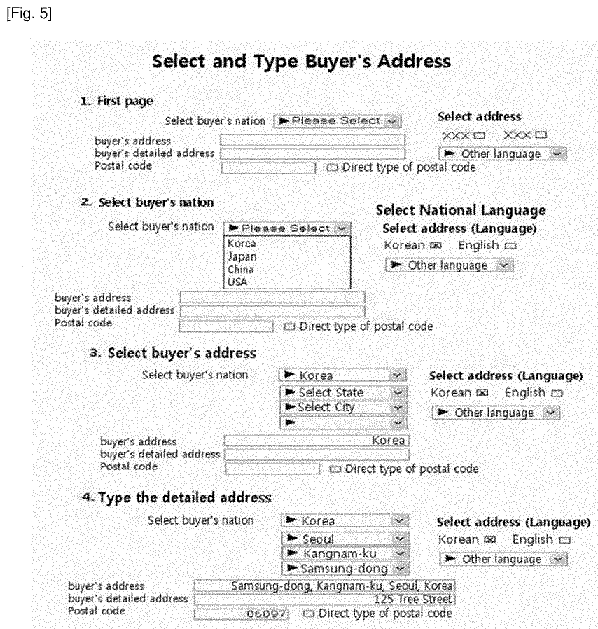

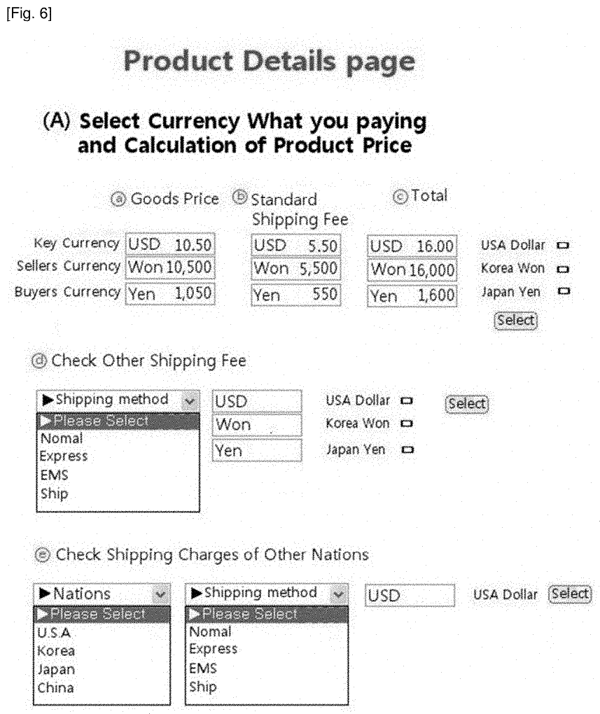

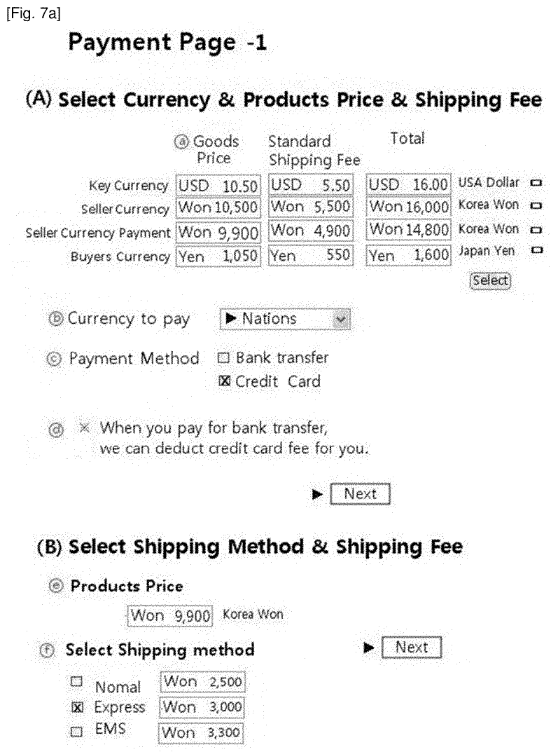

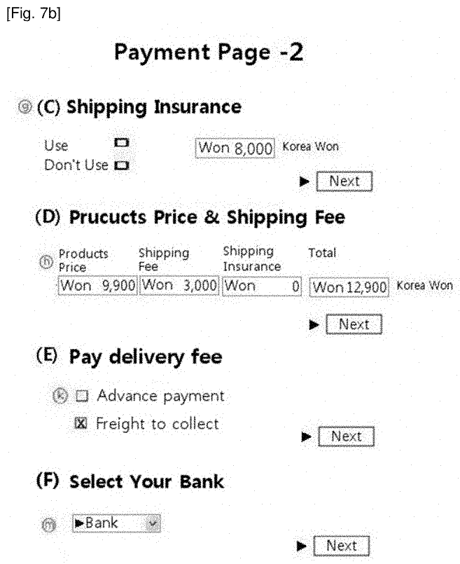

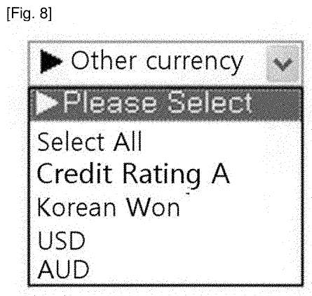

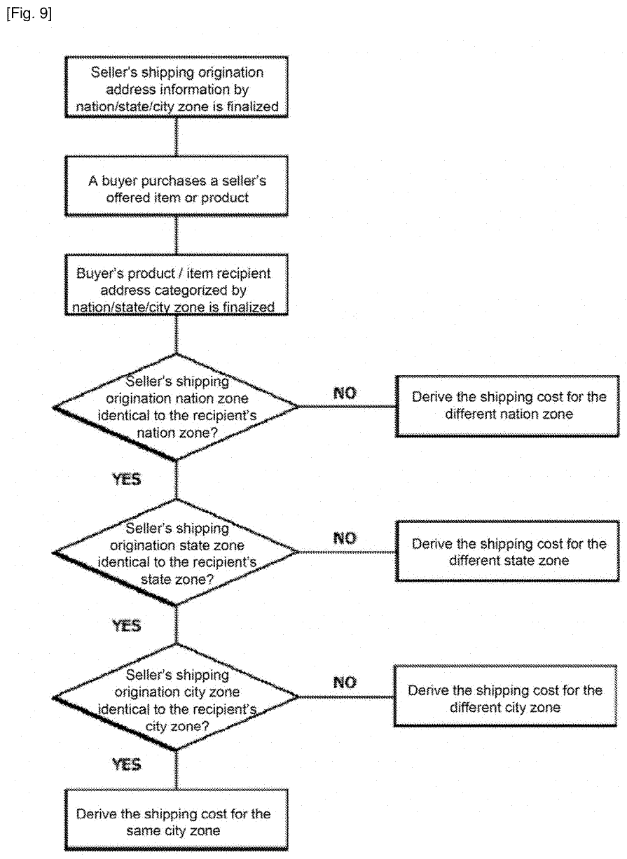

FIG. 1 is a schematic diagram showing a ‘delivery fee calculation system of goods’ in ecommerce according to an embodiment of the present invention. FIG. 2 is a schematic block diagram showing ‘management server’ of FIG. 1. FIGS. 3a and 3b are diagrams showing before and after the delivery zone information is confirmed through the ‘delivery fee calculation system of goods’ of FIG. 1 in ecommerce site. FIGS. 4a and 4b are diagrams showing how to create the address zone, through the ‘delivery fee calculation system of goods’ of FIG. 1 in ecommerce site. FIG. 5 is a diagram showing the ‘confirm unit of receipt address information’ of FIG. 2, and showing the correlation between the Delivery Company's code and the postal code. FIG. 6 is a diagram showing operation of ‘choice unit of delivery method’, and ‘create unit of currency’ of FIG. 2 in ecommerce site. FIGS. 7a and 7b are diagrams showing operation of ‘payment carry out unit’ of FIG. 2 in ecommerce site. FIG. 8 is a diagram showing creating of other currencies through the ‘create unit of currency’ of FIG. 2 in ecommerce site. FIG. 9 is a flowchart showing a calculation process of delivery fee in the ‘delivery fee calculation system of goods’ of FIG. 1, when the ‘information of first delivery zone’ is selected in ecommerce site.

Referring to FIG. 1, ‘Delivery fee calculation system of goods’ in ecommerce according to one embodiment of the present invention is a system which calculates the products delivery charge in domestic or overseas commerce through connected and authenticated ‘seller terminal’ or ‘buyer terminal’ in ecommerce site and through the address information of domestic or oversea registered by the administrator in the ecommerce site, also includes the ‘seller terminal’ (10), the ‘buyer terminal’ (40), the ‘delivery company terminal’ (20), and the ‘management server’ (30).

The seller terminal (10) is a terminal device of seller that wants to access to ecommerce site and sell his own goods after sign up as a seller member. Seller registers goods which seller wants to sale and registers the outbound shipping address with the product information, also seller confirms and enters the delivery zone, the delivery method, the delivery way and the delivery fee for product delivery.

The ‘buyer terminal’ (40) is a terminal device for buyer that wants to purchase the seller's goods as buyer in ecommerce site where he joins the member. Buyer registers goods what he want to buy and also receipt address and then perform payment for the delivery fee of goods in ecommerce site.

‘Delivery company terminal’ (20) is terminal device of Delivery Company that delivers the goods of the seller to the buyer in ecommerce site where he joins the delivery company member. Delivery Company enters the information of delivery zone for delivery. And then Delivery Company delivers the goods to the buyer by seller's request.

The ‘seller terminal’ (10), the ‘buyer terminal’ (40) and the ‘delivery company terminal’ (20) in the present invention are provided and helped with a personal information terminal, such as a Smart phone capable of running Internet browsers and applications, I Pad, PDA (Personal Digital Assistant), HPC (Hand Personal Computer), Web pad, Notebook, WAP (Wireless Application Protocol) Phone, Palm PC, e-Book Terminal, HHT (Hand Held Terminal), PC, Smart TV, etc..

The ‘management server’ (30) is a terminal device of operator entity or management entity provided the service of ‘delivery fee calculation system of goods’. The ‘management server’ implements the ecommerce site as a web or an app, and provides the implemented web or app to the ‘seller terminal’ (10), ‘buyer terminal’ (40), or ‘delivery company terminal’ (20).

If the specific operation of the ‘management server’ (30) will be described with reference to FIG. 2’, the management server includes: ‘create unit of address zone’ (310), ‘input unit of delivery zone’ (320), ‘determination unit of delivery zone’ (325), ‘select unit of delivery goods’ (330), ‘choice unit of delivery method’ (340), ‘create unit of currency’ (350), ‘confirm unit of receipt address information’ (360), ‘calculate unit of delivery fee’ (370), ‘code providing unit’ (381), ‘copy unit of delivery zone’ (382), ‘storage unit’ (383), ‘payment carry out unit’ (384), ‘control unit’ (390).

The address zone of domestic or foreign address consist of city, state zone and nation displayed in respective national languages are generated in the ‘create unit of address zone’ (310), through a ‘management terminal’ that manages an ecommerce site, also these addresses can be linked with the postal code of each country.

Delivery zone information for delivering goods by one or more ‘delivery company terminal’ (20) or ‘seller terminal’ (10) based on the address zone generated by the ‘create unit of address zone’ (310) is inputted in the ‘input unit of delivery zone’ (320).

The delivery zone information is confirmed in the ‘determination unit of delivery zone’ (325) by the ‘seller terminal’ (10).

The product and outbound shipping address information of goods is confirmed by the ‘seller terminal’ (10) and price information about goods is entered in ‘select unit of delivery goods’ (330).

If the ‘information of first delivery zone’ is selected by ‘seller terminal’ (10), the ‘select unit of delivery goods’ (330) provides the ‘information of first delivery zone’ to the ‘storage unit’ (383). The ‘information of first delivery zone’ is set to enable addition, modification and deletion by ‘seller terminal’ (10).

When the ‘information of second delivery zone’ inputted by the ‘delivery company terminal’ (20) is selected, the ‘select unit of delivery goods’ (330) provides the ‘information of second delivery zone’ to the ‘storage unit’ (383). At this time, the ‘seller terminal’ (10) can enters at least one of a bar code and a QR code provided from the ‘delivery company terminal’ (20) and then can select the ‘information of second delivery zone’.

The delivery method, delivery way and delivery fee of goods inputted by ‘seller terminal’ (10) are selected in the ‘choice unit of delivery method’ (340).

A currency about the commodity price inputted by the ‘seller terminal’ (10) is generated in the ‘create unit of currency’ (350). The currency exchange program for exchanging money and currency unit between domestic and foreign currency is installed in advance in ‘create unit of currency’ (350). Information of Key Currency, and information of seller's and buyer's currency that seller and buyer want to receive or pay, and information of exchange rate provided by the delivery company or bank, and fee Information charged when exchanging money by exchange rate information by executing of the exchange program is provided in the ‘create unit of currency’ (350).

Receipt address information receiving specific goods is selected and inputted in the ‘confirm unit of receipt address information’ (360) by ‘buyer terminal’ that want to buy specific goods in ecommerce.

The delivery fee of the specific goods corresponding to the outbound shipping address information and the receipt address information basis on the delivery fee information is calculated in the ‘calculate unit of delivery fee’ (370). If the ‘information of first delivery zone’ inputted by the ‘seller terminal’ (10) is selected, the delivery fee inputted for each nation, each state zone and each city are calculated in the ‘calculate unit of delivery fee’ (370) judging nations, state zones and cities of ‘receipt address information’ corresponding to nations, state zones and cities of ‘outbound shipping address information’ are sequentially the same or not.

The ‘code providing unit’ (381) provides a goods code or a company code to the ‘seller terminal’ (10) or the ‘delivery company terminal’.

The delivery zone information generated by the ‘seller terminal’ (10) or the ‘delivery company terminal’ can be copied and shared in the ‘copy unit of delivery zone’ (382). Also the delivery zone information by request from other ‘seller terminal’ (10) and permission of ‘management terminal’ of ecommerce site is shared in the ‘copy unit of delivery zone’ (382).

The ‘storage unit’ (383) stores the address zone and the delivery zone information, the goods information, the outbound shipping address information, the price information of goods, the delivery method, the delivery ways, the postage, the currency, and the receipt address information for the commodity. A program for processing and controlling of the ‘control unit’ (390) is stored in the ‘storage unit’ (383). The storage unit (383) may perform the function for temporarily storing input/output data. The ‘storage unit’ (383) may include a web storage that performs a storage function on the Internet. The ‘storage unit’ (383) may include a storage medium of at least one type of Flash memory type, hard disk type, multimedia card micro type, Card type memory (e.g., SD or XD memory, etc.), RAM (Random Access Memory), SRAM (Static Random Access Memory), ROM (ROM, Read-Only Memory), EEPROM (Electrically Erasable Programmable Read-Only Memory), PROM (Programmable Read-Only Memory), Magnetic memory, Magnetic disk, or Optical disk.

The payment is performed in the ‘payment carry out unit’ (384) by the ‘buyer terminal’ (40) purchasing the goods, using the information of Key Currency, Seller Currency, Buyer Currency, exchange rate, and fee, which are linked with an external payment server,

The operation of each component configuring the management server is controlled by the ‘control unit’ (390) so that the seller or delivery company can create an optimal delivery zone and calculate the best delivery fees and product price and then use it using the address provided by ecommerce site.

The detailed operation of the ‘delivery fee calculation system of goods’ as configured above will be described in detail. The ‘seller terminal’ (10), the ‘buyer terminal’ (40), the ‘management server’ (30), and the ‘delivery company terminal’ (20) are referred to as the seller, the buyer, the online shop manager, and the delivery company for convenience of explanation.

The seller inputs a unique code of goods received from the online shop manager (see FIGS. 3a and 3b \textcircled{a}), and select the country which the goods are shipped. At this time, the product code is a code given by the online shop manager, and the outbound shipping country of the goods means the country where goods are shipped.

The seller selects the seller country, and then selects the price of the goods to be received after the product is sold, and then enters the product price in FIGS. 3a and 3b \textcircled{b}. The selected country and the entered goods price by the seller become the Seller Currency in FIGS. 3a and 3b \textcircled{h} (see FIG. 6 \textcircled{a} and FIG. 7a \textcircled{a}). In this time, the seller country means the country in which the seller is doing business, and the product price means currency (the same currency as the Seller Currency in FIG. 3a \textcircled{h}) that the seller wants to finally receive. If the seller is doing the business in Korea and the desired currency is Japanese Yen, seller choose Korea in FIGS. 3a and 3b \textcircled{b} and then choose Japan in FIGS. 3a and 3b \textcircled{h}.

And then the seller selects one of the ‘use’ or ‘not use’ in the item whether use the delivery zone of Delivery Company or not (see FIG. 3a \textcircled{c}). At this time, ‘use’ means seller uses the delivery zone created by the delivery company. ‘Not use’ means that the seller creates himself and uses the delivery zone directly.

If seller selects ‘Not use’ in FIG. 3a \textcircled{c}, go to FIG. 4a. The seller creates his own delivery zone here. The delivery company can create a delivery zone here as well, but if an ‘online shop management program’ is linked or compatible with the ‘delivery company management program’, a delivery zone can be automatically generated, It can be automatically updated even if the delivery company zone changes later. As shown in FIG. 9, if the buyer confirms the receipt address of the goods after the seller provides the completed delivery zone, the delivery fee inputted for each nation, each state zone and each city can be calculated judging nations, state zones and cities of ‘receipt address information’ corresponding to nations, state zones and cities of ‘outbound shipping address information’ are sequentially the same or not.

More specifically, when the seller selects the country where shipped in FIG. 4a \textcircled{a}, the address (local administrative system) of the selected country (see FIG. 4b \textcircled{c}) is shown. Determine the number of zones to create in FIGS. 4a and 4b \textcircled{b}. At this time, FIG. 4b is a diagram assuming that two domestic zones and two oversea zones are created. Then, the seller creates the zone using the ‘add’ and ‘remove’ items in FIG. 4b \textcircled{c}. FIGS. 4a \textcircled{d}\textcircled{f} and 4b \textcircled{d} are used later on when seller needs to insert or delete new zones or needs to modify the zones. Also, the zone created by the delivery company is used by the sellers in FIGS. 3a and 3b \textcircled{c}\textcircled{w}\textcircled{x}. In addition, the zone created by the seller and the delivery company can be reused in FIGS. 3a and 3b \textcircled{t}\textcircled{u}, Other sellers can use the seller's delivery zone by permission of the person who created the delivery zone or the online shop manager. Other sellers can use the downloaded zone and modify it to suit oneself.

On the other hand, when the seller selects the ‘use’ item using the delivery zone of the delivery company (for example, select FIGS. 3a and 3b \textcircled{c}), that means, seller uses Delivery Company's zone which Delivery Company with permission of online shop manager inputs.

When the seller selects a country where shipped in FIGS. 3a and 3b \textcircled{a}, local administrative system (Address) of country where shipped appears in FIGS. 3a and 3b \textcircled{c}. The seller can find the delivery companies that the seller can deal with in FIGS. 3a and 3b \textcircled{c}. At this time, the seller visits the delivery company with the packaged goods, and then calculates the delivery price according to each delivery zone, and receives the delivery company code numbers, bar code or QR code, and seller applies the one of the delivery company's code number, bar code and QR code in FIGS. 3a and 3b \textcircled{w}\textcircled{x}. In this case, the seller can fill in the delivery fee directly or apply the delivery fee set by the delivery company.

Also, the seller can find and apply a desired delivery company in FIGS. 3a and 3b \textcircled{c}, and the seller can directly fill in the delivery fee or apply the delivery fee set by the delivery company.

An example of applying a delivery company's zones and fees is as follows.

For example, if you only use normal, express, and registered as the delivery method from the post office north of Samsung-dong, Gangnam-gu, Seoul, Korea, the delivery company code will be “0082 02 05 01 01 005 4 5 5 7 8 9”. If seller uses the delivery fees set by the delivery company, the code will be “0082 02 05 01 01 005 4 5 5 7 8 9 1”, and if the seller directly enters the delivery fee, the code will be “0082 02 05 01 01 005 4 5 5 7 8 9 2”. Explaining each code separately, 0082 is Korea, 02 is Seoul, 05 is Gangnam-gu, 01 is Samsung-dong, 01 is a north of Samsung-dong, 005 is Korean post office (the delivery company's unique number), 4 is a weight of commodity, 5 is a volume of commodity, 5 is 5 items of goods (quantity of commodity), 7 is normal (delivery methods), 8 is express (delivery methods), 9 is registered (delivery methods), 1 is delivery charges set by delivery company (who set the delivery charges), 2 is delivery charges set by seller (who set the delivery charges).

In addition, if the management system of the online shop is compatible with the governmental system that sets the address and postal code of each country, the administrator of the online shop does not have to input the address manually. Also, modified addresses (local administrative system or street, road) and zip codes can be updated automatically.

The local delivery code can be used by a national postal code. If postal code of “Korea Seoul Gangnam-gu Samsung-dong” will be 8855, delivery code will be ‘0082 8855 01 005 4 5 5 7 8 9 1’

At this time, the codes consist of numbers or letters may be changed to bar codes or QR code.

Also, the changed barcode or QR code can be received by email and easily inputted by a mobile phone touch method. For example the letters entered by Delivery Company are Korea, Seoul, Gangnam-gu, Samsung-dong, north, post office, commodity weight, commodity volume, commodity quantity, normal, express, registered. The number or symbol is a type of ‘0082 02 05 01 01 005 4 5 5 7 8 9 1”. It can be implemented by bar code or QR code.

Also, the seller can select a delivery company by dividing the domestic and the overseas when selects the delivery company in FIGS. 3a and 3b \textcircled{w}\textcircled{x}. When ‘A’ delivery company is cheap delivery fee in domestic and ‘B’ Delivery Company is cheap delivery fee in overseas, seller choose ‘A’ delivery company for domestic and ‘B’ delivery company for overseas. Also, the seller can use different delivery companies in the delivery method of FIGS. 3a and 3b \textcircled{d}. For example, if ‘A’ delivery company is cheap in normal delivery and ‘B’ Delivery Company is cheap in express delivery, the seller can choose and use inexpensive delivery company.

When the delivery zone is formed as described above, the result is shown like FIG. 3b \textcircled{p}.

Referring to FIGS. 3a and 3b \textcircled{d}, the ‘Standard Delivery’ means a one of delivery method and a delivery fee that the buyer can view on the Product Details Page (see FIG. 6). If the seller selects the ‘Standard Delivery’ as Express Delivery (see FIGS. 3a and 3b \textcircled{d}), the Express Delivery fee is shown on the Product Details Page. If the seller does not select ‘Standard Delivery’, the cheapest delivery fee will be shown on the Product Details Page. If the seller chooses only one item such as Normal or Registered, this delivery fee will be the Standard Delivery.

The seller selects another delivery method after set the ‘Standard Delivery’.

Generally, if the seller is a Korean in online shop, seller wants to receive the money of the sold product with Korean currency, unless it is special case. Internationally sold product prices may not be settled in Korean won. For example, if the buyer is an American, he/she will pay the bill in US dollars, and if buyer is a Chinese, he/she will try to pay the Chinese Renminbi. In addition, factors arise between the countries as follows; exchange rate calculation, exchange fee, general bank fee, credit card fee, etc. In the present invention, such information can be accurately calculated and provided to a seller or a buyer.

Referring to FIGS. 3a and 3b \textcircled{h}, the concept of a Key Currency, Seller Currency, Other Currency and Buyer Currency will be described. First, the Key Currency is the currency that is the basis for all currencies, and Key Currency is usually USD, also seller can set an Other Currency as Key Currency. Usually Seller Currency is the currency of the country where the seller is doing business and seller inputs the product price as Seller Currency. For example, if the seller is Korean, the Korean won will be Seller Currency. And if the seller is Japanese, Japanese yen is Seller Currency. And if the seller is an American, the USD will be Seller Currency (in this case, the Seller Currency and the Key Currency are the same). Also, if the seller is Japanese, the Seller Currency may be set to US dollars (USD) instead of JPY. Currencies in the world belong to Other Currency. The Buyer Currency is the currency paid by the buyer who wants to purchase the commodity in online shop, and is displayed on the Product Details Page of FIG. 6 and the Product Payment Page of FIG. 7a. The following factors may determine the Buyer Currency; IP tracking of the person who will connect the online site and purchase the product (logoff), and the buyer has entered buyer's address on the online shop site in advance (login) etc.

The ‘delivery fee calculation system of goods’ in ecommerce can program the currency unit of each country in advance. The Korean currency can be programmed to be Won only, and the US currency can be programmed to be separated into Dollars and Cents.

The exchange fee, which is a commission received by the bank usually generated during the transaction of each country's currency, is entered by the seller. However, the bank may also provide services for the seller after including the exchange fee in advance, the ecommerce site and the bank's program needs to be linked in this case.

The card fee is a fee paid by the seller to the bank when the buyer uses the credit card as shown in FIGS. 3a and 3b \textcircled{m}. The card fee can be entered by the seller. The card fee is usually included in the product price. If the buyer transfers the account without using the credit card, credit card fees can be added or subtracted in FIG. 7a. \textcircled{c}, \textcircled{d}. In addition, other fee items can be created separately by seller in FIGS. 3a and 3b \textcircled{m}, and the seller can add the shipping handling fee, shipping insurance and other expenses.

In addition, the ‘Add Other Currency’ and ‘Delete Other Currency’ items can be used in FIGS. 3a and 3b \textcircled{n}, \textcircled{o}, when the seller add or remove other currencies because later the seller does not want the currency of the specific country for personal reasons or political reasons.

If the buyer confirms the goods receipt address when registering as a member or purchasing goods in ecommerce site, it is linked to the delivery charge related to the delivery zone that the seller has confirmed (see FIG. 9). Here, the goods buyer can fill in the zip code and the detailed address, and the other address must use what the administrator has entered (name of the local administrative system).

‘1 of FIG. 5’ is the first page shown when buyers select and type goods receipt address, and when sellers and buyers sign up, and when the buyers purchase a product.

When buyer selects the country and region of the goods receipt place, it is displayed the main language of the selected country and region or language of computer operating system and English, and then buyer select one of languages in 2 of FIG. 5. Other languages may be selected by the buyer. Here, English is a language in the same sense as a Key Currency in currencies, Depending on the privileges of the online shop manager. English can be displayed in one of other languages. The language information selected by the buyer is shown to the seller later, The language is converted into the seller's country or region or the main language of the computer operating system, and viewed. Sellers can also see addresses in other languages. The languages showing in the screen are not a translation of the automatic translation, but the address letter of each country is entered by the online shop manager directly.

When the buyer's delivery address is selected in 3 of FIG. 5, the postal code is automatically inputted. If the postal code is incorrect or not displayed, the buyer enters the postal code directly. Finally, the buyer types the detailed address in 4 of FIG. 5.

When the goods receipt address is completed, the delivery fee for each delivery zone provided by the seller is selected automatically. You can see place names with same spelling for each country or globally. In the case of Korea, there are the same names such as Jung-gu, Seo-gu, Dong-gu, Nam-gu and Buk-gu in each city. In this case, people can recognize that the Dong-gu is a part of the XX city, but the computer cannot recognize which is not programmed. As a way to recognize this, we can only use FIG. 9 or the delivery code (FIG. 2 ‘code providing unit’) related to each address (name of local administrative system).

If the address system created by the ecommerce administrator and the address system of the zip code designated by each country are compatible with the same system as shown like in FIG. 9 and the delivery code (FIG. 2 code providing unit), the zip code can also be automatically generated and displayed when the buyer selects an address, and the address or zip code can be automatically updated later even if the zip code or address are changed. As another example, if ‘0082 02 05 01’ (the code of the delivery company) or ‘Samsung-dong, Gangnam-gu, Seoul, Korea’ (the letter address) is determined, ‘XXX-XX’ (postal code) of ‘Samsung-dong, Gangnam-gu, Seoul, Korea’ can be automatically marked. In this case, the letter address, area code, and zip code of Delivery Company are not same characters, but it means the same.

In this case, if the address writer memorizes the postal code after selecting country and language in 2 of FIG. 5, buyer can type the postal code directly in the ‘Postal Code’ entry field, and then address (local administrative system) related to that postal code is automatically displayed even if it is not selected. In this case, buyer only needs to type the postal code and the detailed address.

The ‘delivery fee calculation system of goods’ in ecommerce is a system to provide to buyers after calculate the product price and delivery cost accurately using the product price specified by the seller, the delivery fee specified by delivery company or seller, the exchange rate of each country provided by the bank, use of credit card provided by P.G company, and the credit rating of each country provided by the credit rating company.

It is automatically pre-checked ‘1’ in ‘Quantity’ item (FIGS. 3a and 3b \textcircled{e}) and ‘Normal’ of the ‘Standard Delivery’ item (FIGS. 3a and 3b \textcircled{d}), when the delivery zone is created, In this case, when the seller deals with Registered only, seller clears the checked items and checks the ‘Registered’ items.

For automatic calculation of exchange rate , If the seller selects ‘Use’ item in FIGS. 3a and 3b \textcircled{g} and chooses a Bank in ‘Bank Name’ item, the exchange rate of each country offered by the bank can be used manually (Select only part of the currency) or automatically (Full selection of currency).

If the seller selects ‘Use’ item in FIGS. 3a and 3b \textcircled{g} for automatic calculation of exchange rate and chooses Credit Rating Company in ‘Credit Rating Company’ item that seller trusts (see FIGS. 3a and 3b \textcircled{g}), the credit rating of each country is linked to the automatic calculation of exchange rate table (see ‘Other Currency’; FIGS. 3a and 3b \textcircled{h}).

Sellers use data provided by Credit Rating Companies If the seller chooses ‘Credit Rating A’ in FIG. 8, only the currency of the country above credit rating A is selected for the ‘Other Currency.’ this means, the seller will refuse to accept the currencies below ‘Credit Rating A’. Currencies below ‘Credit Rating A’ are not displayed in ‘Other Currency’ in this case. If the buyer, who uses the currency below ‘Credit rating A’, wants to purchase the goods, the program leads the Key Currency as the product price. Also the Buyer Currency is displayed as a Key Currency on Product Details Page of FIG. 6. If the currency system of the present invention is used in an online shop after online shop can register a Business Registration and open bank account in each country, buyer members who purchase the product in each country can transfer their country currency to their country bank, and buyers can save money exchange fees and other bank fees.

P.G (Pay Gate) Company has P.G Company and Bank. The sellers who want to trade choose P.G Company. At this time, the seller may select a plurality of P.G companies.

The seller can apply the Key Currency in ‘Key Currency’ item of FIGS. 3a and 3b \textcircled{h}.

The Key Currency is the currency that is the basis for all national currencies, usually US dollars (USD) will be Key Currency. In special cases, the seller may set the currency of another country as a Key Currency. The exchange rates of all national currencies are automatically calculated based on this Key Currency. Other currencies are automatically calculated according to the exchange rates offered by the bank, if the Key Currency is selected.

The seller can apply the Seller Currency in ‘Seller Currency’ item of FIGS. 3a and 3b \textcircled{h}. Seller Currency is the money that the seller receives the product price ultimately. The Korean is a Korean won, the American is USD. Seller is Korean where he stays in Korea, but seller can select USD and Key Currency as Seller Currency. In this case, Seller Currency is invisible and shows only the Key Currency and Buyer Currency on Product Details Page and Preview of FIG. 6. The currency displayed on the Product Details Page and Preview is Key Currency, Seller Currency, and Buyer Currency basically. If the seller wants, he can make other currencies visible.

The seller may set the exchange fee in FIGS. 3a and 3b \textcircled{k}. Seller can use the bank's exchange fee automatically and also the seller can type the exchange fee directly. The exchange fee that received by bank is around 3% for USD and 6% for other currencies.

So seller will judge and apply it by oneself.

The delivery price and delivery cost showing on Product Details Page and Product Payment Page of FIGS. 6 and 7a are shown with all inclusive prices, such as both goods price (delivery cost), card fee, and exchange fee.

If seller selects ‘Select All’ in ‘Other Currency’ item in FIG. 8, the seller chooses the entire exchange rate provided by bank.

Even if the seller selects ‘Selects All’ or ‘Credit Rate A’ in the automatic calculation table of exchange fee, only the Key Currency and Seller Currency is shown in FIGS. 3a and 3b \textcircled{r}, and the remaining currencies are hidden. If seller wants to see the currency of the specific country, seller can choose to show it.

Seller can select and apply exchange rates for specific countries. If buyer of countries where isn't selected by the seller wants to buy the goods, the buyer must buy the goods paying the Key Currency.

Seller can add (FIGS. 3a and 3b \textcircled{n}) and remove (FIGS. 3a and 3b \textcircled{o}) currency of the required country.

The seller can create the currency manually, after selects ‘Not Use’ item in FIGS. 3a and 3b \textcircled{g}.

The seller may use the exchange rate provided by the bank, after selecting Bank in the ‘Bank Name’ item. Seller must obtain bank authorization in this case. If seller selects ‘Not Use’ item (FIGS. 3a and 3b \textcircled{g}) in automatic calculation of exchange rate, seller enters the currency of each country and the exchange rate manually in FIG. 3a \textcircled{p}\textcircled{q}\textcircled{r}.

Seller can select Credit Rating Company and P.G Company after seller must obtain the permission from Credit Rating Company and P.G Company to use it.

Seller can apply Key Currency, Seller Currency, Buyer Currency and Other Currency in ‘Currency’ item of FIGS. 3a and 3b \textcircled{h}.

Also seller can enter the Exchange Fee directly in FIGS. 3a and 3b \textcircled{k}. Seller can enter the Card Fee directly in FIGS. 3a and 3b \textcircled{m} and also can create separate items and enter other fees.

If the seller selects a few countries in ‘Other Currency’ item of FIG. 3a \textcircled{h}, the seller can enter the exchange rate manually in FIG. 3a \textcircled{q}, \textcircled{r}.

Seller can add the currency manually in FIG. 3a \textcircled{p}. The exchange rate that the seller calculated himself (not related to the exchange rate offered by the bank) applies in FIG. 3a \textcircled{q}, or seller can apply the number of currencies directly in FIG. 3a \textcircled{t}. Sellers can create currencies as many as they like in this way. If the exchange rate changes a lot later, the seller has to calculate and input the new exchange rate. All input must be done manually by the seller himself. A currency that is not needed afterwards can be deleted by pressing the ‘Delete’ button (FIG. 3a \textcircled{q}).

The delivery company can provide all or part of the delivery charges (FIGS. 3a and 3b \textcircled{w}\textcircled{x}) related to the delivery method (FIGS. 3a and 3b \textcircled{d}) and quantity of the goods (FIGS. 3a and 3b \textcircled{e}) to the seller. If the seller wants to manually generate the delivery method and quantity, seller checks the delivery method and the quantity of the goods one by one, and sets the delivery fee. If the seller wants to create a detailed delivery zone and corresponding delivery method, seller has a lot of job, that's why seller can be finished appropriately.

If seller reckons that his product is valuable, the seller can select and use only the Registered. If seller's product is a perishable agricultural or marine product that needs to be shipped quickly, seller can choose Express only.

Seller can use this function when a seller creates and uses a delivery zone directly, and later needs a delivery zone for another product. This saves time and effort creating a new zone. Here, domestic and overseas delivery companies can be used separately. More specifically, seller applies and uses the function (see FIGS. 3a and 3b \textcircled{t}) about other products, after copying the created zone set by other seller or delivery company. Seller applies and uses the function (see FIGS. 3a and 3b \textcircled{u}) about other products, after copying the created zone and their delivery fee set by other seller or delivery company.

Seller can copy and use the zones created by other sellers located in similar outbound shipping place of product. In this case, seller should get permission from other seller who uses zone in advance. Also the seller can copy another seller's zone and modify it to suit him and use it.

If buyer selects the desired product in FIG. 6, ‘Product price+delivery fee=total product price’ is automatically calculated for each currency of each country, and can view on Product Details Page by IP tracking or buyer's address tracking that was entered by buyer already in online shop site. In this case, the exchange fee, card fee, and other fees are all combined.

The buyer can preview all the delivery methods offered by the seller, and select the best delivery method in FIG. 6 \textcircled{d}.

Buyers can view delivery fees about each currency of each country in FIG. 6 \textcircled{e}, and purchase the product with applying delivery fee.

When the buyer selects the product price and the delivery fee on ‘Product Details Page’, the same prices are showed on ‘Product Payment Page’ (FIG. 7a), and the buyer can make the last modification on ‘Product Payment Page’.

The currency shown on ‘Product Details Page’ and ‘Product Payment Page’ is Key Currency, Seller Currency and Buyer Currency (IP trace as the currency of the country that the buyer is viewing on the computer, or if the buyer has entered the address in advance) basically. If the currency of the buyer's country is invisible and only the Key Currency and real currency are shown, either the seller has not selected that currency or the country is below the ‘Credit Rating A’ (for example, a credit rate of buyer country is below ‘Credit Rating A’). In this case, it is possible to pay only the Key Currency to purchase the goods.

If seller is Korean, and Seller Currency is Korean Won, and the online shop's headquarters in the USA has a bank account in Korea, and buyer is Korean who lives in USA, and also has a bank account in Korea, the buyer can purchase the good and can pay Korean Won in Korea Bank. In this case, buyer can save the money for exchange fee. If the buyer pays the product price as ‘Seller Currency Payment’ by cash or money transfer, card fees and exchange fees are automatically removed from the product price. If the buyer pays the goods price by credit card, only the exchange fee is automatically cleared.

The seller can choose another national currency and it will display on the ‘Product Details Page’ besides Seller Currency, Buyer Currency and Key Currency.

Buyer can select one of the Key Currency, Seller Currency and Buyer Currency in FIG. 7a \textcircled{a}, or selects Nation in the ‘Currency to Pay’ item of FIG. 7a \textcircled{b}, and selects Payment Method in ‘Method of Payment’ item.

If buyer selects the ‘Seller Currency Payment’ item in FIG. 7 \textcircled{a}, the exchange fee (FIG. 7a \textcircled{d}) disappears and also discounts are available on delivery fee.

If the buyer selects ‘Bank Transfer’ in Pay Method' item of FIG. 7a \textcircled{c}, card fees are exempt (FIGS. 3a and 3b \textcircled{m}) as entered in the program.

Check the product price and the currency of the applicable country again in FIG. 7a \textcircled{e}, and the delivery price can be confirmed once again In FIG. 7a \textcircled{f}. The Delivery Method may be changed here again.

The buyer selects the ‘Shipping Insurance’ whether or not to insure in FIG. 7b \textcircled{g}.

The buyer finally confirms everything including the product price and the delivery charge in FIG. 7b \textcircled{h}.

The buyer can choose to ‘Advance Payment’ or ‘Freight to Correct’ in FIG. 7b \textcircled{k} and choose the bank to pay with credit or debit card in FIG. 7b \textcircled{m}.

The ‘delivery fee calculation system of goods’ in ecommerce means, the seller can present the optimum price which determines goods price and delivery fee with minimum effort to the buyer, because the commodity delivery charge is calculated in ecommerce of domestic or overseas, through connected and authenticated ‘seller terminal’ (10) or ‘buyer terminal’ (40) in ecommerce site, and through the address information of domestic or oversea registered by the administrator in the e-commerce site. In addition, one embodiment of the present invention, it is possible to improve the work efficiency of not only the manager of the ecommerce site but also the seller and the delivery company because seller, buyer, and delivery company use the address information provided by the manager of the ecommerce site together.

A sound-absorbing layer may be applied to the inside of the outer case of the management server (30) of the present invention.

As the nonwoven fabric constituting the sound-absorbing layer, a needle punch nonwoven fabric may be used.

Examples of the fibers constituting the sound-absorbing layer made of the needle punch nonwoven fabric include polyester fibers, nylon fibers, polypropylene fibers, acrylic fibers and natural fibers.

The thickness of the sound-absorbing layer is preferably 0.3 to 15 mm. If the thickness of the sound absorbing layer is less than 0.3 mm, a sufficient sound absorbing effect can not be obtained. If the thickness is more than 15 mm, the space inside the outer case of the management server 30 is reduced, not.

The weight of the sound-absorbing layer is preferably 10 to 1000g/m2. If the value is less than 10g/m2, a sufficient sound absorbing effect can not be obtained. If it the value is more than 1000g/m2, the lightness of the outer case of the management server (30) can not be ensured.

The fineness of the fibers constituting the sound-absorbing layer is preferably in the range of 0.1 to 30 decitex. At less than 0.1 decitex, the fineness of the fibers is not preferable because the absorption of low frequency noises is difficult and the cushioning property is lowered.

If the fineness of the fiber exceeds 30 decitex, it is not preferable to absorb high frequency noise. The fineness of the fibers constituting the sound-absorbing layer is optimally in the range of 0.1 to 15 decitex.

When the sound-absorbing layer is provided inside the outer case of the management server (30), noise during operation of the management server (30) can be reduced.

A coating layer coated with the anti-fouling coating composition may be formed on the surface of the payment performing unit (384) In order to effectively prevent and prevent the adhesion of contaminants.

Boric acid and sodium carbonate are contained in a molar ratio of 1:0.01 to 1:2 on the composition for anti-contamination application. The total content of boric acid and sodium carbonate is 1 to 10% by weight based on the total aqueous solution.

Sodium or calcium carbonate may be used as a material for improving the coatability of the application layer, but sodium carbonate may further be used.

The molar ratio of boric acid and sodium carbonate is preferably 1:0.01 to 1:2. When the molar ratio is out of the above range, there is a problem that the coating property of the base material is lowered or the moisture adsorption on the surface after coating is increased to remove the coating film.

The boric acid and the sodium carbonate are preferably used in an amount of 1 to 10% by weight in the aqueous solution of the premix composition.

When the content is less than 1% by weight, the coating property of the base material is deteriorated. When the content is more than 10% by weight, crystal precipitation tends to occur due to an increase in the coating film thickness.

The spraying method is preferably a method of applying the present anti-fouling coating composition onto a substrate. The thickness of the final coated film on the substrate is preferably 500 to 2000 Å, more preferably 1000 to 2000 Å.

When the thickness of the coating film is less than 500 ANGSTROM, there is a problem that it deteriorates in the case of high temperature heat treatment. If the thickness of the coating film exceeds 2000 Å, there is a disadvantage that crystal deposition on the coated surface tends to occur.

The antifouling coating composition may be prepared by adding 0.1 mol of boric acid and 0.05 mol of sodium carbonate to 1000 mL of distilled water and stirring.

Since the composition for preventing contaminants is applied to the surface of the payment performing unit (384), it is possible to effectively prevent and prevent the adhesion of contaminants.

As described above, the present invention is not limited to the embodiments as it is only one embodiment In order to carry out the ‘delivery fee calculation system of goods’ in ecommerce. As claimed in the following patent claims, a person who has ordinary skill without departing from the gist of the invention in the field to which the invention belongs is a technical spirit of the present invention to the extent that anyone can make various changes.

The present invention allows presenting a buyer in an online store with a list of products originating from a plurality of sellers, including product prices and shipping prices. I.e., instead of providing the buyer only with a list of products and calculating the shipping price only after the product was selected, the online store of the present invention displays a list of products each of which being displayed with price and shipping cost.

For that when a buyer enters the online store, he is prompted to enter his shipping address. Alternatively, the buyer is prompted to login to his preregistered account in which the shipping address is already stored.

Next, the buyer conducts a search for the desired product, such as by selecting a category of products or entering a free text in a designated search field.

The online store then retrieves the relevant products and the price associated with the product, as provided by the seller.

The online store then calculates the shipping cost for each of the products, in accordance with the seller's address, the delivery address and the size of the products. Calculating the shipping cost takes into consideration the shipping company preselected by the seller and according to an example, also shipping method preselected by the buyer, such as regular vs. overnight delivery etc. It will be appreciated that the seller's address does not necessarily refer to the seller's office address, rather may refer to the storage place in which the selected products are stored.

For that the online store is provided by each of the sellers with a list of products including the storage address of each product and the delivery company preselected by the seller.

Finally, the online store displays the search results including products associated with the search input of the buyer, price of each product and shipping price of each product.

Once the buyer concludes his shopping, the online stores sends the seller of each of the selected products order instructions. In addition, the online store converts the shipping address, as inputted by the buyer, to a delivery zone adapted in accordance with the address format of the shipping company preselected by the seller. The online store then sends the formatted delivery address to the delivery company along with any other delivery instructions.

This way, the online store allows the buyer to search and selects the desired products taking into consideration the delivery costs which are precalculated in accordance with the seller's address, delivery company and delivery address.

Those skilled in the art to which the presently disclosed subject matter pertains will readily appreciate that numerous changes, variations, and modifications can be made without departing from the scope of the invention, mutatis mutandis.

1. A method for managing online shopping at an online store offering products of a plurality of sellers, the method comprising:
receiving from a plurality of sellers lists of products and product information associated with each product, said product information including location address said product, size of said product, price of said product and a selected shipping company; said lists of products and product information is stored in a product database;
receiving from a plurality of shipping companies delivery costs and address format, said delivery costs includes parameters for calculating delivery cost in accordance with products size, and delivery address; said delivery costs and address format is stored in a delivery database;
prompting a from to enter delivery address;
receiving from a buyer a product input including an indication regarding a desired product;
conducting a search in said product database in accordance with said product input and retrieving a list of relevant products;
retrieving from said delivery database delivery costs of each of said relevant products in accordance with said selected shipping company;
calculating shipping price of each of said relevant products in accordance with the location address, the delivery address, size of the relevant product, and the selected shipping company; and
displaying to the buyer the list of relevant products including price of each product and shipping price of each product.

2. The method in accordance with claim 1 further comprising:
receiving from the buyer an indicated of at least one selected product;
sending a seller of the selected products order instructions;
converting the delivery address to a delivery zone adapted in accordance with the address format of the selected shipping company associated with said selected product;
sending said delivery zone to the selected shipping company along with product information.
